(19) United States
(12) Patent Application Publication
(10) Pub. No.: US 2007/0229723 A1
(43) Pub. Date: Oct. 4, 2007

(54) LIQUID CRYSTAL DISPLAY

(75) Inventor: Tien-Chun Huang, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QUANTA DISPLAY INC., Tao Yuan Shien (TW)

(21) Appl. No.: 11/534,255

(22) Filed: Sep. 22, 2006

(30) Foreign Application Priority Data
Mar. 28, 2006 (TW) 95110673

(51) Int. Cl. G02F 1/136

(52) U.S. Cl. 349/43

(57) ABSTRACT

A liquid crystal display (LCD) includes an insulating substrate, a gate line formed over the insulating substrate, an active layer formed on the gate line, a source line formed over the insulating substrate and extending substantially perpendicular to the gate line, and a drain line coupled to a pixel electrode, extending across the overlapping region of the active layer and the gate line. The gate line comprises first and second width portions, and the first width portion is narrower than the second width portion and overlaps the drain line.

### BACKGROUND OF THE INVENTION

1. Field of the Invention

The invention relates to a liquid crystal display (LCD) and more particularly to a structure for an LCD capable of reducing gate-drain parasitic capacitance and suppressing variation in gate-drain parasitic capacitance.

2. Description of the Related Art

FIG. 1 is a plan view of a conventional thin-film-transistor LCD (TFT-LCD) 10. The TFT-LCD 10 comprises a gate line 11 disposed horizontally on an insulating substrate (not shown), wherein the gate line 11 has a protruding region serving as a gate electrode 12. An active layer 13, made of amorphous silicon or the like, is formed on the gate electrode 12. A source line 14 extends perpendicularly across the gate line 11 and has a protruding region acting as a source electrode 15. A drain line 16 connected to a pixel electrode 18 extends parallel to the gate line 11 and has a drain electrode 17. The source electrode 15 and drain electrode 17 respectively overlap two opposite sides of the gate electrode 12. The pixel electrode 18 is generally made of a transparent conductive material having good conductivity, such as indium-tin-oxide (ITO) and indium-zinc oxide (IZO).

During photolithography, deviation of masks induced by machine variance during formation of TFTs causes variation in the overlapping region of source electrode 15/drain electrode 17 and the gate electrode 12, accordingly resulting in variations in gate-source parasitic capacitance (abbreviated as C_{GS} hereafter) and gate-drain parasitic capacitance (abbreviated as C_{GD} hereafter). FIG. 2 shows an equivalent circuit of a pixel unit in a TFT-LCD to illustrate the effect of C_{GD} on LCD illumination. In FIG. 2, G represents a gate electrode, S represents a source electrode, D represents a drain electrode, C_{LC} represents a liquid crystal capacitance, and C_{S} represents a storage capacitance, wherein the two capacitances C_{LC} and C_{S} are connected in parallel between a pixel electrode P and a common electrode C. When the TFT-LCD is turned on, the gate electrode G is applied with a relatively high voltage V_{GH}, and the relation between the total charge Q1 in the TFT-LCD and voltage V_{P1} of the pixel P is expressed as:

Q1=C_{GD}(V_{P1}−V_{GH})+(C_{LC}+C_{S})(V_{P1}−V_{COM}) (1),

wherein V_{COM} denotes the voltage of the common electrode.

Conversely, when the TFT-LCD is turned off, the gate electrode G is applied with a relatively low voltage V_{GL}, with the relationship between the total charge Q2 in the TFT-LCD and the voltage V_{P2} at the pixel P is expressed as:

Q2=C_{GD}(V_{P2}−V_{GL})+(C_{LC}+C_{S})(V_{P2}−V_{COM}) (2).

Due to charge conservation, that is, Q1=Q2, it is derived from formulae (1) and (2) as:

ΔV_{P}≡V_{P1}−V_{P2}=(V_{GH}−V_{GL})(C_{GD}/(C_{CL}+C_{CS}+C_{GD})) (3).

As shown in formula (3), ΔV_{P}, the so-called feedthrough voltage, is dependent on C_{GD}. Since L_{CD} brightness is controlled by adjusting the voltage of the pixel P, LCD brightness suffers non-uniformity of brightness due to deviation of C_{GD} caused by machine variance. In more serious cases, the so-called “mura” phenomenon can occur.

In addition to the above problem, the LCD flicker may occur due to the excessive C_{GD} as effective voltage varies from one field to the next field.

When gate-drain parasitic capacitance is increased, time constant of the gate line is increased accordingly. As a result, gate voltage is delayed when moving from high to low from driving side towards the other remote side, inducing “rewriting” in regions neighboring the remote side. Rewriting means that data (i.e., drain potential) of the horizontal period next to a predetermined horizontal period is written in the predetermined period, shifting the potential of a predetermined pixel.

Further, as shown in FIG. 2, when the gate voltage is turned from high to low, parasitic capacitance of TFT causes voltage at the pixel electrode to drop ΔV_{P}, as expressed in formula (3). When ΔV_{P} increases, voltage difference between source electrode and drain electrode also increases. Accordingly, when gate voltage is turned from high to low from driving side towards the other remote side, rewriting induced by gate voltage delay occurs more easily. As shown in formula (3), ΔV_{P} has a close relationship with C_{GD}. When C_{GD} is decreased, ΔV_{P} is decreased accordingly. For this reason, the rewriting can be suppressed by decreasing C_{GD}.

In consideration of the above-mentioned problems, a structure for an LCD capable of reducing gate-drain parasitic capacitance and suppressing variation in gate-drain parasitic capacitance is desirable.

### BRIEF SUMMARY OF THE INVENTION

Accordingly, it is one object of the present invention to provide an LCD capable of suppressing variation in gate-drain parasitic capacitance induced by inaccurate alignment of machines, thereby preventing variation in illumination in diverse LCD regions. Moreover, the LCD has reduced gate-drain parasitic capacitance, and hence prevents screen flicker.

It is another object of the present invention to provide an LCD comprising an insulating substrate, a gate line formed over the insulating substrate, an active layer formed on the gate line, a source line formed over the insulating substrate and extending substantially perpendicular to the gate line, and a drain line coupled to a pixel electrode, extending across the overlapping region of the active layer and the gate line, wherein the gate line comprises a first width portion and a second width portion, and the first width portion is narrower than the second width portion and overlaps the drain line.

It is still another object of the present invention to provide an LCD comprising an insulating substrate, a gate line formed over the insulating substrate, an active layer formed on the gate line, a source line formed over the insulating substrate and extending across the gate line and having an extension region, and a drain line coupled to a pixel electrode, extending across the overlapping region of the active layer and the gate line and having at least one extension region formed on one side of the extension region of the source line and the overlapping region of the active layer and the gate line, wherein the gate line comprises a first width portion and a second width portion, and the portion of the first width portion is narrower than the second width portion and overlaps the drain line.

### BRIEF DESCRIPTION OF THE DRAWINGS

The invention can be more fully understood by reading the subsequent detailed description and examples with references made to the accompanying drawings, wherein:

FIG. 1 is a plan view of a conventional thin-film transistor-LCD (TFT-LCD);

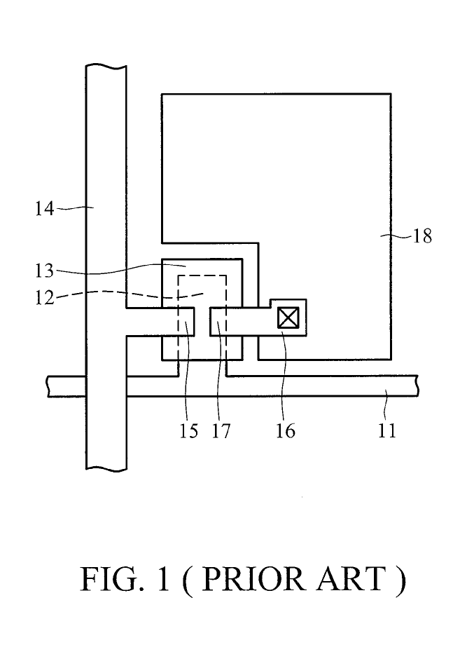

FIG. 2 shows an equivalent circuit of a pixel unit in a TFT-LCD to illustrate the effect of C_{GD} on LCD illumination;

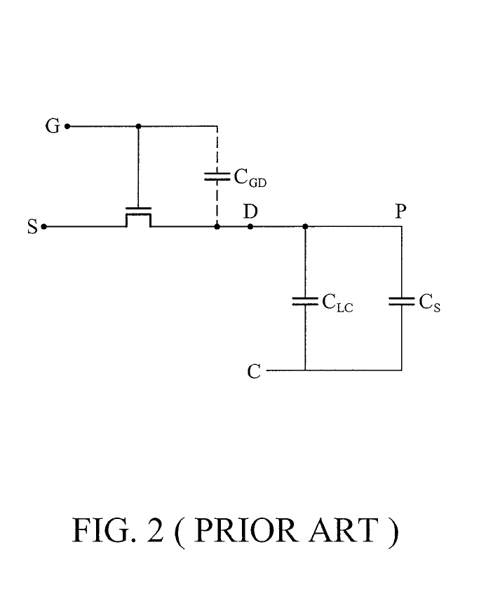

FIG. 3 is a plan view of an LCD in accordance with an embodiment of the invention; and

FIG. 4 is a plan view of an LCD in accordance with another embodiment of the invention.

### DETAILED DESCRIPTION OF THE INVENTION

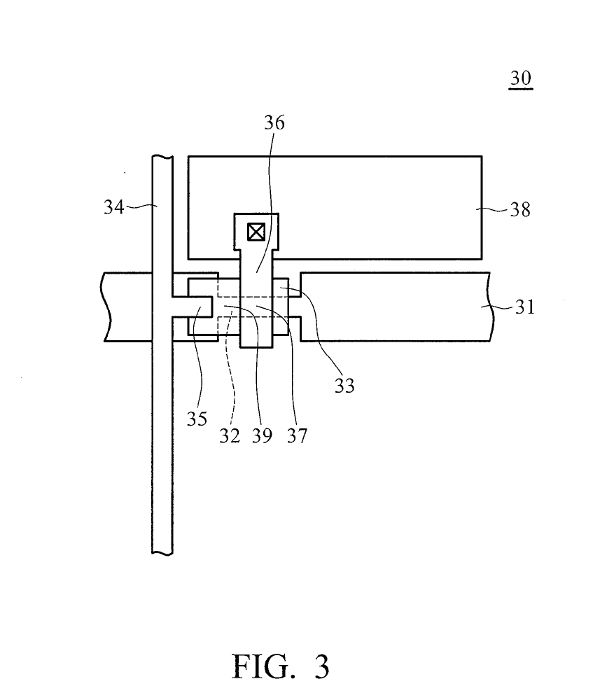

FIG. 3 is a plane view of an LCD in accordance with an embodiment of the invention. In an LCD 30, a gate line 31 is formed over an insulating substrate (not shown). As shown, the gate line 31 has a first width portion and a second width portion, wherein the first width portion is narrower than the second width portion. An active layer 33 is formed on the first and second width portions. The gate line 31 has a gate electrode 32 on the overlapping regions of the first and second width portions and the active layer 33. A source line 34 is formed over the insulating substrate and extends substantially perpendicular to the gate line 31 to cross the gate line 31, and has an extension region on the active layer 33 acting as a source electrode 35. A drain line 36 extends substantially perpendicular to the gate line 31 across the overlapping region of the active layer 33 and the first width portion of the gate line 31. The source line 36 has a drain electrode 37 disposed on the active layer 33 and coupled to a pixel electrode 38. A channel region 39 is defined between the source electrode 35 and drain electrode 37 within the active layer 33.

As shown in the figure, since the drain line 36 extends beyond the boundary of the overlapping region of the active layer 33 and gate line 31, even when misalignment occurs, the area of the overlapping region of the gate line/gate electrode 31/32, active layer 33 and drain line/drain electrode 36/37 does not change. As a result, C_{GD} does not change, and non-uniform brightness is prevented. Moreover, since the gate line 31 has the first width portion of narrower width, and the drain line 36 overlaps the first width portion, area of the overlapping region of the gate line/gate electrode 31/32, active layer 33 and drain line/drain electrode 36/37 is reduced, thereby decreasing C_{GD} and suppressing the screen flicker.

It is noted that the first width portion of the gate line 31 needs not to overlap only the drain line 36, but can be extended towards the source line 34.

Further, the first width portion of narrower width of the gate line 31 provides free space around two sides of the first width portion. Accordingly, in another embodiment of the invention, the drain line 36 can further have an extension region, formed on one side of the first width portion and located on the boundary of the overlapping region of the active layer 33 and the gate line 31. As such, the channel region between the drain line 36 and source line 34 is increased, increasing the conducting current.

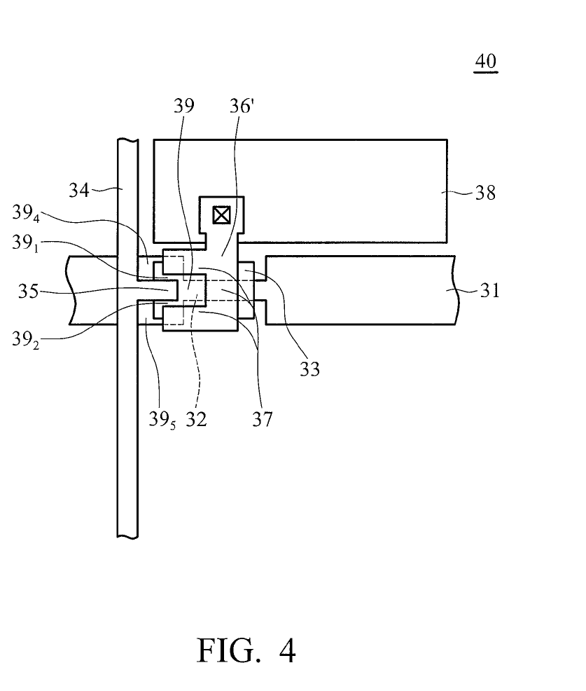

FIG. 4 is a plane view of an LCD 40 in accordance with another embodiment of the invention, differing from LCD 30 only in that the drain 36′ line further includes two extension regions respectively formed on two sides of the extension region 35 of the source line 34 and located on the overlapping region of the active layer 33 and the gate line 31. Resultantly, the channel region defined between the source electrode 35 and the drain electrode 37 within the active layer 33 now includes channel regions 39, 39₁ and 39₂.

As shown in the figure, compared to the channel region 39 in FIG. 3, LCD 40 has two additional channel regions 39₁ and 39₂. Further, the active layer can extend towards the source line, and upwards/downwards. In this case, there are further two more channel regions 39₄ and 39₅.

While the invention has been described by way of example and in terms of preferred embodiment, it is to be understood that the invention is not limited thereto. To the contrary, it is intended to cover various modifications and similar arrangements. Therefore, the scope of the appended claims should be accorded the broadest interpretation so as to encompass all such modifications and similar arrangements.

What is claimed is:

1. A liquid crystal display (LCD) comprising:
an insulating substrate;
a gate line formed over the insulating substrate;
an active layer formed on the gate line
a source line formed over the insulating substrate, extending substantially perpendicular to the gate line;
a pixel electrode; and
a drain line coupled to a pixel electrode, extending across the overlapping region of the active layer and the gate line,
wherein the gate line comprises a first width portion and a second width portion, and the first width portion is narrower than the second width portion and overlaps the drain line.

2. The LCD of claim 1, wherein the drain line has at least one extension region formed on the boundary of the overlapped region of the active layer and the gate line, respectively.

3. The LCD of claim 1, wherein the source line extending across the gate line has an extension region formed on the boundary of the overlapping region of the active layer and the gate line.

4. The LCD of claim 3, wherein the drain line has at least one extension region formed on one side of the extension region of the source line and located on the boundary of the overlapping region of the active layer and the gate line.

5. The LCD of claim 4, wherein the drain line has two extension regions respectively formed on one side of the extension region of the source line and located on the boundary of the overlapping region of the active layer and the gate line.

6. The LCD of claim 1, wherein the gate line comprises a gate electrode formed on the first width portion and part of the second width portion.

7. The LCD of claim 3, wherein the extension region of the source line acts as a source electrode.

8. The LCD of claim 1, wherein the region of the drain line overlapping the first width portion of the gate line acts as a drain electrode.

9. The LCD of claim 1, wherein the drain line extends beyond the boundary of the overlapping region of the active layer and the first width portion.
